(19) United States
(12) Patent Application Publication
(10) Pub. No.: US 2006/0164227 A1
(43) Pub. Date: Jul. 27, 2006

(54) Control device and priming method for an element protecting a vehicle passenger and/or a road user

(76) Inventors: Martin Auer, Ostelsheim (DE); Horst Brauner, Steinenbronn (DE); Ernst-Ludwig Doerr, Stuttgart (DE); Rainer Justen, Altdorf (DE); Hans Roehm, Wildberg-Sulz (DE); Wolfgang Ruedt, Benningen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/533,470

(22) PCT Filed: Aug. 16, 2003
(86) PCT No.: PCT/EP03/09094

§ 371 Date: Oct. 25, 2005

(30) Foreign Application Priority Data
Oct. 31, 2002 (DE) 10250732.5

(51) Int. Cl. B60Q 1/00

(52) U.S. Cl. 340/457.1

(57) ABSTRACT

A control device for preventively actuating a vehicle safety device, comprises a decision stage which issues a triggering decision the vehicle safety device if travel behavior of the vehicle which is critical for safety is detected, based on dynamic translational movement parameters. In addition, a plausibility checking stage checks the triggering decisions, evaluates it as implausible (and prevents triggering of the vehicle savety device) if an evaluation of the time profile of parameters which are sensed in the vehicle, such steering angle, activation of pedals, yaw rate or lateral acceleration, reveals that the travel behavior which is critical for safety corresponds, within predefinable limits, to a desired travel behavior. A travel behavior which is brought about in a deliberate and controlled fashion is considered to be a desired travel behavior.

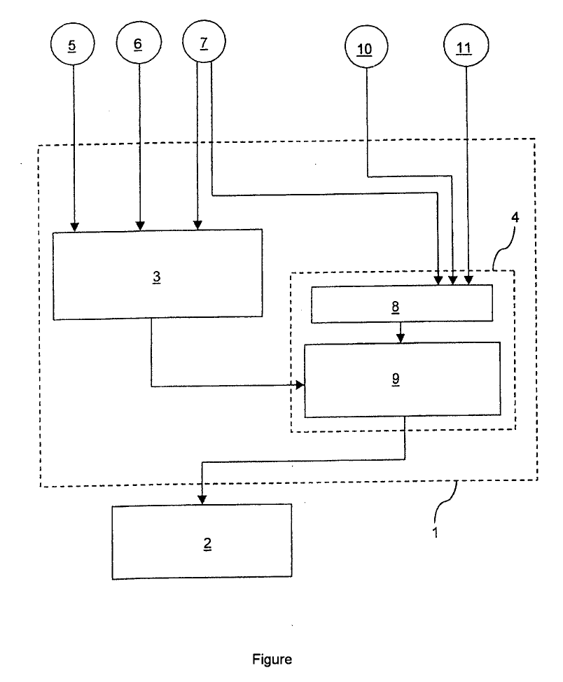

### BACKGROUND AND SUMMARY OF THE INVENTION

This application claims the priority of German patent document 102 50 732.5, filed Oct. 31, 2002 (PCT International Application PCT/EP2003/009094, filed Aug. 16, 2003), the disclosure of which is expressly incorporated by reference herein.

The invention relates to a method and apparatus for actuating a means vehicle safety system.

German patent document DE 100 29 061 A1 discloses a vehicle occupant protection system having an electromotive device for pretensioning a seatbelt, and a control device for actuating the seatbelt pretensioner. The control device determines whether a potential accident situation is occurring based on dynamic translational movement parameters such as travel speed, yaw angle, yaw acceleration, lateral acceleration and longitudinal acceleration and manipulated variables such as pedal travel, pedal force or steering angle. If a potential accident situation is determined, the electromotive seatbelt pretensioner is actuated and triggered.

In such a vehicle occupant protection system it is possible for undesired triggering of vehicle occupant protection systems to occur (for example for the seatbelt to be pretensioned unnecessary, and in particular without this appearing appropriate to the driver or to other vehicle occupants).

A comparable problem may occur with road-user protection devices, such as an engine hood which can be raised preventively, extendable pedestrian impact elements or surface elements of the vehicle whose hardness can be adjusted.

International patent document WO 01/79036 A1 discloses a generic arrangement for substantially reducing undesired triggering processes of a restraint device in a motor vehicle. A rollover decision, which is made based on a rotational speed sensed in the vehicle, is used to trigger the restraint device. In order to avoid undesired triggering, a plausibility checking device uses acceleration values which are sensed in the vehicle to carry out a plausibility check of the rollover decision (that is, to determine whether the rollover decision is plausible). Only a rollover decision which is determined to be plausible causes triggering of the restraint device. Plausibility checking is carried out, for example, by a combined threshold value interrogation for longitudinal acceleration and lateral acceleration.

One object of the present invention is to achieve improved plausibility checking of a triggering decision for vehicle safety devices, which reduces the number of undesired triggering processes.

This and other objects and advantages are achieved by the control device and method according to the invention, for preventively actuating a vehicle safety system, which prevents undesired and/or unnecessary triggering, or at least reduces the probability of such an occurrence. In particular the driver, other vehicle occupants, and/or pedestrians, are not annoyed or unnecessarily disrupted.

By virtue of the invention, deployment of a reversible protection means, such as a seatbelt pretensioner, can be reduced. As a result, the service life of protection means which can be actuated and which have a limited number (for example 500) of guaranteed triggering cycles is lengthened and/or smaller and more favorable restraint systems with a smaller number of guaranteed triggering cycles can be used.

According to the invention, an output signal of a dynamic movement control system and/or an output signal of a brake assistance system can be used as input signal of the decision stage. For example, a triggering decision is taken if a predefinable signal of a dynamic movement control system and/or a brake assistance system is sensed. The predefinable signal may be, for example, an activation signal—that is, a signal which is output in order to intervene in vehicle translational dynamics when the dynamic movement control system and/or the brake assistance system are activated. This has the advantage that a prompt triggering decision is made possible.

One factor in the plausibility check according to the invention is the detection of a travel behavior of the vehicle which is brought about by the driver in a deliberate and controlled fashion, as opposed to travel behavior which is due, for example, to reflex actions and rapid reactions and/or a travel behavior which is not actively brought about by the driver.

It is particularly advantageous if the plausibility checking of a triggering decision is evaluated quickly by the plausibility checking stage. In order to permit very rapid plausibility checking, in one advantageous embodiment of the invention a desired travel behavior is determined in parallel (or at least virtually simultaneously) with the triggering decision, by considering a limited preceding time period of, for example, five seconds or one minute; that is using parameters which are sensed or which describe this time period. As a result, reliable plausibility checking can be carried out on a triggering decision in real time, without a significant delay.

In particular controlled and manipulated variables which are predefined by the driver (such as the steering angle and pedal positions and in particular the change in the controlled and manipulated variables over time) and system settings which are predefined by the driver (for example, the status—the switching on and switching off—of a traction controller or of a dynamic movement control system) are used for checking the plausibility of the triggering decision, and in particular whether the travel behavior which is critical for safety is a desired travel behavior (travel behavior of the vehicle which is brought about by the driver in a deliberate and controlled fashion).

Parameters relating to a driver and to a stretch of road, such as the driving style or customary route selection, can also be used to determine the desired travel behavior. Further parameters which are sensed in the vehicle and which can advantageously be used to determine the desired travel behavior are dynamic movement parameters.

A desired travel behavior can be inferred, for example, from the time profile, such as the amplitude, frequency or speed of a change of dynamic movement parameters over time, as parameters which are indicative of the travel behavior.

In one advantageous embodiment of the invention, the plausibility checking stage uses the temporal change of a parameter that characterizes movement dynamics, in order to check the plausibility of a triggering decision. The plausibility checking stage evaluates a triggering decision as implausible if the rate of change over time of such parameter falls below a predefinable threshold for the speed of change (i.e., changes only very slowly). For example, in the case of a slow yaw rate (one which does not increase suddenly but rather over a relatively long time period of, for example, several seconds), a triggering decision which is taken on the basis of a sensed yaw rate value which is above a threshold value is rejected as implausible, because a travel state which is brought about by the driver in a deliberate and controlled fashion is inferred. Such travel states occur, for example, during test circuit runs or on helical multistorey carpark entry ramps in which the travel speed is slowly increased with an unchanged curve radius.

This example can be applied to all other parameters (for example, attitude angle or braking torque) which indicate a travel state that is critical for safety. Test situations and presentation situations are also detected from the profile of the sensed parameters and triggering of a protection means is prevented.

On the other hand, uncontrolled changes in travel states (for example, changes in travel states which surprise the driver) still trigger the vehicle safety system.

In another advantageous refinement of the invention, a travel behavior which is brought about by the driver in a deliberate and controlled fashion is inferred if a comparable travel situation occurs with a predefinable frequency (within a predefinable time interval). If, for example, an emergency braking operation takes place for the third time in two minutes, with the initial speed at the start of braking being between 60 and 80 km/h in each case, a travel behavior which is brought about in a deliberate and controlled fashion is inferred. In the example described it may be assumed that a test situation or presentation situation is occurring.

Likewise, understeering or oversteering and other travel states which are critical for safety and which have different initial speed ranges may cause a triggering decision to be evaluated as implausible. An essential factor with this refinement is that a predefinable number of repetitions (at least one) of a travel situation which is critical for safety takes place within a predefinable time period. Above the predefinable number of repetitions the plausibility checking stage then prevents this travel situation from serving as a basis for the triggering of the means for protecting vehicle occupants.

In this context use is made of the fact that, after actual situations which are critical for safety, the traffic situation and the driving style are such that an identical situation which is critical for safety does not occur again within a short time period of, for example, twenty seconds or two minutes. That is, a similar or a largely identical situation is not repeated within such a time period. In particular, this applies to a multiple repetition within a short time period.

In order to increase the reliability of plausibility checking, further criteria can be additionally checked by the control device according to the invention. For example, in the case of an emergency braking situation which occurs repeatedly within a few minutes it is possible to check further whether the steering angle or the yaw rate have an identical or at least similar value in each emergency braking situation. A travel situation which is brought about in a deliberate and controlled fashion is inferred,, and the triggering decision which occurs on the basis of the emergency braking situation is evaluated as implausible only if this condition is fulfilled.

In a further refinement of the control device according to the invention, exceptional travel situations are also predefined, with a triggering decision being filtered out as implausible, and the triggering of a means for protecting vehicle occupants being prevented, only when one of the predefined exceptional travel situations occurs. These exceptional travel situations restrict the range of the travel situations which do not lead to triggering of a means for protecting vehicle occupants to a predefinable set of selected situations so that a triggering decision can be evaluated as implausible with a particularly high degree of reliability.

The occurrence of an exceptional travel situation is detected by the control device from, for example, a predefinable dynamic movement pattern which is characteristic of this exceptional travel situation. A predefinable dynamic movement pattern means that a value range is defined for a set of dynamic movement parameters and the values of different dynamic movement parameters have a specified relationship to one another (that is, the value ranges have a predefinable relationship).

As an alternative, or in addition, exceptional travel situations can also be characterized by manipulated variables such as steering angle and position of the accelerator pedal.

Furthermore, in order to characterize and detect exceptional travel situations by means of the plausibility checking stage it is also possible to use ambient parameters such as for example the external temperature, the road conditions, the coefficient of friction between the tire and underlying surface, the position of the vehicle which is sensed by means of a position sensing system, the distance from a vehicle traveling in front or from objects in the surroundings of the vehicle, the type of road (freeway, village road, residential road, carpark).

According to the invention, these parameters can of course also be used advantageously to determine whether the travel behavior which is critical for safety corresponds to a desired travel behavior.

Exceptional travel situations can be characterized in particular by a predefinable statistical relationship and/or by a predefinable dynamic relationship of value ranges. It is also possible to characterize and detect an exceptional travel situation by reference to the dynamic profile of a single dynamic movement parameter. Exceptional travel situations which can be predefined and detected by means of characteristic parameters are, for example, traveling in a circle, slalom travel, test braking, drifting around a bend, traveling on snow or ice etc. as well as combinations thereof.

In a further refinement of the control device according to the invention, the plausibility checking stage checks the plausibility of a triggering decision, based on parameters that are indicative of a change in the activation state and a change in the operating state of a dynamic movement control system which can be switched on and off by a system or manually by the driver. (The “operating state” in this context refers to whether the system is switched on or off, while the “activation state” refers to whether it is currently intervening in control of the vehicle.) Since lower threshold values may apply to situations which are critical for safety when the dynamic movement control system is switched on than when the dynamic movement control system is switched off, it is possible that a change in the operating state could bring about a triggering decision. Such a triggering decision, brought about by the change in the operating state, is undesired, and is rejected by the plausibility checking stage.

For example, in the case of a skidding process as a travel behavior which is critical for safety, both the operating state of a dynamic movement control system (dynamic movement control system on/off) and the activation state of the dynamic movement control system (intervention in the movement dynamics: yes/no) are sensed. A triggering decision is then rejected as implausible if the dynamic movement control system has not changed from the off operating state into the on operating state until just before the triggering decision.

Other objects, advantages and novel features of the present invention will become apparent from the following detailed description of the invention when considered in conjunction with the accompanying drawings.

### BRIEF DESCRIPTION OF THE DRAWINGS

The single figure shows a block diagram of a control device according to the invention for actuating a means for protecting vehicle occupants.

### DETAILED DESCRIPTION OF THE DRAWINGS

According to the invention, actuation of a means for protecting vehicle occupants refers not only to vehicle occupants protection devices such as seat belt pretensioners, knee cushions, seat components which can be adjusted in terms of position or hardness, and other supporting and damping elements which can be actuated, but also the actuation process for closing a sun roof or the side windows, or adjustment of a seat into a position which is optimum in terms of a collision. Of course, a means for protecting road users such as for example an engine hood which can be adjusted in terms of its angle of inclination or a pedestrian impact damping element which can be extended can also be actuated in the same way and using the same control device.

Referring to the FIGURE, the control device 1 comprises a decision stage 3 and a plausibility checking stage 4. The reference numeral 2 designates a vehicle occupant protection system.

The decision stage 3 senses parameters 5, 6 and 7, in particular dynamic movement parameters, which originate, for example, from control devices and sensors such as an ABS controller, a wheel speed sensor, a yaw rate sensor or a sensor for sensing the surroundings. The decision stage 3 determines, by means of the sensed parameters 5, 6, 7, whether a travel behavior of the vehicle which is critical for safety is occurring, and if appropriate outputs a triggering decision, corresponding to the travel behavior which is critical for safety, for the means 2 for protecting vehicle occupants. The triggering decision may be composed of a single signal for activating the occupant protection device 2 or may also include the triggering time, characteristic, speed, degree of triggering and the actuation period of the protective device 2.

The plausibility checking stage 4 comprises a first substage 8 for determining a “desired travel behavior”, (i.e., a travel behavior of the vehicle which is brought about by the driver in an intentional and controlled fashion), and a second substage 9 for evaluating the triggering decision. The first substage 8 uses parameters 7, 10, 11 which are sensed in the vehicle, for example the steering angle, the wheel speeds, the displacement of the accelerator and brake pedals, and the yaw rate (and/or the time profile of these parameters) to determine the desired travel behavior. In particular, for the purpose of plausibility checking it is also possible to use parameters which are not taken into account by the decision stage 3. The desired travel behavior which is determined is transmitted to the second substage 9.

The second substage 9 senses the desired travel behavior which is determined by the first substage 8 and the travel behavior which is critical for safety and is transmitted by the decision stage 3, and compares whether the desired travel behavior corresponds, within predefinable limits, to the travel behavior which is critical for safety. If so, the second substage evaluates the triggering decision based on the travel behavior which is critical for safety as implausible and prevents the means for protecting vehicle occupants from being actuated on the basis of this triggering decision.

The first and second substages can also be configured as a single stage which uses the sensed parameters 7, 10, 11 and the triggering decision which is determined by the decision stage 3 and/or the travel behavior which is determined and is critical for safety.

If the triggering decision is classified by the plausibility checking stage 4 as plausible or if the plausibility which is determined is at least high enough, this leads to the triggering decision being enabled and the means 2 for protecting vehicle occupants being actuated. The actuation can be carried out directly by the plausibility checking stage 4.

Alternatively, the plausibility checking stage 4 enables a direct actuation of the vehicle occupant protection means 2 by the control device 1, in particular by the decision stage 3 or a control stage which is provided for that purpose.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-8. (canceled)

9. Control apparatus for a motor vehicle, for preventively actuating a vehicle safety device for protecting vehicle occupants and/or road users, said apparatus comprising:
a decision stage which generates a triggering decision for the vehicle safety device if a travel behavior of the vehicle which is critical for safety is determined, based on dynamic vehicle movement parameters; and
a plausibility checking stage for checking plausibility of the triggering decision; wherein,
the plausibility checking stage evaluates the triggering decision as implausible and prevents actuation of the vehicle safety device if an evaluation of time profile of parameters that are sensed in the vehicle reveals that the travel behavior which is critical for safety corresponds, within predefinable limits, to a desired travel behavior, which is brought about in a deliberate and controlled fashion by a vehicle operator.

10. The control device as claimed in claim 9, wherein the plausibility checking stage uses a parameter which is indicative of rate of change in the travel behavior of the vehicle to check the plausibility of the triggering decision.

11. The control device as claimed in claim 10, wherein the plausibility checking stage evaluates the triggering decision as implausible and prevents the vehicle safety device from being actuated if the travel behavior of the vehicle has only made a slow approach to the travel behavior which is critical for safety.

12. The control device as claimed in claim 11, wherein the plausibility checking stage evaluates the triggering decision as implausible and prevents the actuation of the vehicle safety device if a change in the travel behavior of the vehicle within a predefinable time period has taken place only with a rate of change which is below a predefinable threshold value.

13. The control device as claimed claim 12, wherein the plausibility checking stage evaluates the triggering decision as implausible and prevents the vehicle safety device from being actuated if a predefinable number of repetitions of the same travel behavior which is critical for safety took place within a predefinable time period.

14. The control device as claimed claim 13, wherein the plausibility checking stage evaluates the triggering decision as implausible and prevents the actuation of the vehicle safety device only if the travel behavior which is critical for safety corresponds to a predefinable exceptional travel situation.

15. The control device as claimed in claim 14, wherein the vehicle safety device can be triggered in a reversible fashion.

16. The control device as claimed in claim 15, wherein the vehicle safety device is a seatbelt pretensioner.

17. A method for preventively actuating a vehicle safety device in a motor vehicle, said method comprising:
generating a triggering decision for the vehicle safety device only if a travel behavior of the vehicle which is critical for safety is detected, based on dynamic vehicle movement parameters;
evaluating time profiles of parameters that are sensed in the vehicle;
determining the triggering decision is implausible, if, based on said evaluating, it is concluded that the critical travel behavior corresponds, within predefinable limits, to a desired travel behavior, which is brought about by the driver in a deliberate and controlled fashion;
prevent actuation of the vehicle safety device in response to a determination that the critical travel behavior corresponds within said limits, to said desired travel behavior.

18. A method for controlling operation of a vehicle safety device, said method comprising:
determining dynamic behavior of the vehicle based on vehicle movement parameters;
detecting occurrence of a critical dynamic behavior of the vehicle based on said determined dynamic behavior;
generating a trigger signal for actuating the vehicle safety device upon detection of said critical dynamic behavior;
determining a desired travel behavior based on vehicle control parameters that have values or profiles that are indicative of deliberate vehicle control activity by a vehicle driver;
comparing said detected critical dynamic behavior of the vehicle with the desired travel behavior; and
inhibiting a triggering of said vehicle safety device when said critical dynamic behavior corresponds within specified limits to said desired traveling behavior.
